(19) United States
(12) Patent Application Publication
(10) Pub. No.: US 2007/0279166 A1
(43) Pub. Date: Dec. 6, 2007

(54) Replacement circuit breaker for electric panelboards

(76) Inventor: Daryl J. VanderVeen, Hanford, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/445,785

(22) Filed: Jun. 2, 2006

(51) Int. Cl. H01H 9/02

(52) U.S. Cl. 335/202

(57) ABSTRACT

An improved circuit breaker for electric panelboards is configured to facilitate replacement of an existing circuit breaker when its buss bar mount is damaged due to circuit overload or other fault conditions. The improved circuit breaker has an extension section that extends the breaker housing to a buss bar connector on a distally positioned buss bar and an electrical connector in the extension section that engages the distal bar connector thereon. The improved circuit breaker is provided with a cavity on the bottom side thereof that is sized and configured to substantially straddle the damaged buss bar connector on the proximally positioned buss bar, to which the replaced circuit breaker was originally connected. In an alternative embodiment, preferably configured for twin or quad circuit breakers, a second electrical connector is provided in the cavity to engage a non-damaged proximal bar connector to better divide the electrical draw between buss bars.

### CROSS-REFERENCE TO RELATED APPLICATIONS

None.

### BACKGROUND OF THE INVENTION

A. Field of the Invention

The field of the present invention relates generally to electric power distribution systems utilizing a panelboard having two or more power supply buss bars to deliver electrical power to one or more electrical circuits. More particularly, the present invention relates to circuit breakers utilized in such panelboards. Even more particularly the present invention relates to circuit breakers configured to either utilize more than one buss bar or straddle a damaged portion of one of the buss bars.

B. Background

Electrical power delivered to residential, commercial and industrial buildings from a source of electrical power, such as an electrical generating station via transmission lines, generally passes through the building's electrical power distribution system to distribute electricity to a plurality of individual branch circuits in the building so as to provide power for lights, machines and other electrical uses. The typical electrical power distribution system has a panelboard that interconnects input wires from the transmission system to the building's branch circuits. Disposed between the input wires and the branch circuits are circuit interrupters that are configured to protect the building's branch circuits and the items connected thereto from power overloads and fault conditions. The most commonly utilized circuit interrupters are circuit breakers that comprise contacts which electrically connect to the panelboard, contacts that attach to the electrical circuit and an operating mechanism disposed therebetween that automatically electrically disconnects the two contacts upon determination of an electric overload or fault condition. The standard circuit breakers also include an external switching mechanism that allows the user to selectively disconnect electrical power delivery to the attached branch circuit. A number of different circuit breaker configurations are commonly available and the internal operation and use thereof are well known to those skilled in the art of such devices. For instance, in one configuration, commonly referred to as a twin breaker or dual breaker, the circuit breaker is effectively two breakers joined together to share a single electrical connector. In another configuration, a quad breaker has four breakers joined together to share two electrical connections.

The typical panelboard has a plurality of main power supply buss bars that connect to the branch circuits and a main service disconnect circuit breaker that allows the user to interrupt the delivery of electrical power from the transmission lines to the buss bars and, therefore, all of the building's branch circuits. The buss bar is configured as a conductor, typically made out of copper or aluminum, that serves as the common connection for two or more branch circuits. The electrical contact portion of the circuit breakers are adapted to electrically connect to the buss bars. As well known in the art, there are a variety of different types of panelboards and circuit breakers that utilize different configurations for the electrical and physical connection between the circuit breakers and the buss bars. In one common configuration, which is primarily utilized for a residential meter/breaker combination panel, the buss bars are provided with a plurality of outwardly projecting buss bar connectors or posts that the electrical connector portion of a circuit breaker engages to obtain the necessary electrical contact and to secure the circuit breaker in the panelboard. In this configuration, the circuit breaker is provided with a plug-on jaw at one end and a rail connector at the opposite end, typically referred to as the wire terminal end, where the branch circuit connects. The plug-on jaw is configured to engage the buss bar connector. The rail connector is configured to engage a mounting rail running parallel to the buss bar. Typically, the rail connector of the circuit breaker engages the mounting rail in a manner that allows the user to pivot the circuit breaker down toward the buss bar so that the plug-on jaw securely engages the buss bar connector.

Panelboards are provided with either a single column or row of circuit breaker locations or provided with multiple columns or rows of such locations. The typical panelboard has two parallel, spaced apart power supply buss bars, a parallel mounting rail and one or more neutral or ground buss bars per column or row of circuit breaker locations. The power supply buss bars, neutral buss bars and mounting rails are fixed to the inside bottom of an open front panel box, which is enclosed by a cover plate, occasionally referred to as a dead front cover. The cover plate has a plurality of knock-out panels through which, when the panels are knocked out, the front of the circuit breaker extends to allow the user access to the manual disconnect switch thereon. In circumstances where not all of the circuit breaker locations in a column or row are being utilized, the user simply leaves the knock-out panels in place, thereby covering up this section of the buss bar. In single column or row configurations, the circuit breaker extends from the single mounting rail to engage the plug-on jaw with the first or proximal buss bar connector, that being the one positioned nearest the mounting rail. The distal buss bar and its connectors, not being utilized for circuit breakers, are covered up by a portion of the cover plate. In most meter/breaker combination panels, the manufacturer utilizes a standardized buss bar, which is the same buss bar used in sub-panels wherein both sides are being utilized. Generally, the manufacturer also produces a twin or duplex circuit breaker that is configured to mount on a single buss bar that was originally designed for one full sized breaker. This results in two circuits being fed from a location (i.e., having the same surface area for the connection) that was originally only configured for one circuit.

Unfortunately, an overload or fault situation or corrosion can result in one or more buss bar connectors being burned or otherwise damaged, resulting in the inability to transfer electrical current through to the circuit breaker and the branch circuit in the building. If there is an empty portion of the buss bar available, the user would connect the affected branch circuit to a new circuit breaker and then place the new circuit breaker in the position of one of the unused buss bar connectors. Alternatively, the user could install a twin breaker or a quad breaker to double up on an available bussing. If, as is frequently the situation, there are no unused buss bar connector locations in the panelboard to connect the affected branch circuit, then the user must replace or have replaced the entire panelboard or add an additional sub-panel in order to re-feed the circuits. Replacing an entire panelboard and/or adding a sub-panel is labor intensive and requires purchase of a new panelboard, making it quite costly. An alternative approach, heretofore unavailable, would be to utilize the buss bar connectors on the adjacent buss bar.

What is needed, therefore, is an improved circuit breaker that is configured to fit in place of the existing circuit breaker but utilize the buss bar connector on the distal buss bar instead of the connector on the damaged proximal buss bar. The preferred circuit breaker should be configured to straddle or otherwise bypass the damaged buss bar connector on the proximal buss bar and connect instead to the buss bar connector on the distal buss bar. The preferred circuit breaker should be sized and configured to be positioned under the breaker cover without replacement thereof. Also, for a dual/duplex breaker or quad breaker configuration, the preferred circuit breaker can be configured to connect to the buss bar connectors on both the proximal and distal buss bars, assuming the buss bar connector on the proximal bar is not damaged, thereby assuring contact with the same amount of surface area as a full sized breaker.

### SUMMARY OF THE INVENTION

The replacement circuit breaker for electrical panelboards of the present invention solves the problems and provides the benefits identified above. That is to say, the present invention discloses a new and improved circuit breaker that provides a preferred alternative to adding a sub-panel or replacing a panelboard when all of the buss bar connectors are being utilized and one of the connectors is damaged or otherwise becomes unuseable. The improved circuit breaker of the present invention is sized and configured to extend from the mounting rail to the distal buss bar to connect the electrical connector to the buss bar connector thereon in a manner that straddles and bypasses the damaged buss bar connector on the proximal buss bar. The improved circuit breaker substantially reduces the costs of repairing a damaged panelboard. The improved circuit breaker can also be configured to provide an improved twin breaker by allowing each of the joined circuit breakers to directly connect to a buss bar connector instead of having to share a single buss bar connector, thereby greatly decreasing the likelihood of damage even occurring.

In one general aspect of the present invention, the improved circuit breaker has a breaker housing with a terminal end that connects to a branch circuit to deliver electricity to the structure and a connector end that connects to a power buss bar mounted on the bottom wall of the panelboard's box section. The terminal end is adapted to connect, preferably in a pivotal manner, to a mounting rail. The standard panelboard has a pair of parallel buss bars positioned parallel to the mounting rail, one located proximally thereto and one located distally thereto. The prior art circuit breaker engages a proximal bar connector on the proximal buss bar. The improved circuit breaker of the present invention has an extension section that extends the breaker housing to the distal buss bar. A distal electrical connector located in the extension section near the connector end of the circuit breaker engages a distal bar connector on the distal buss bar. A cavity is provided on the bottom side of the breaker housing to allow the circuit breaker to substantially straddle the damaged proximal bar connector on the proximal buss bar. Other than the addition of the extension section and the cavity, the circuit breaker can be made of the same materials and components as existing or prior art circuit breakers and be configured to engage a variety of different types of buss bar connectors. Use of the improved circuit breaker allows the user to effectively bypass the damaged proximal bar connector on the proximal buss bar, thereby eliminating the need to replace an entire panelboard when other circuit breaker positions are not available. In an alternative embodiment, a second electrical connector is provided in the cavity to connect to a non-damaged proximal bar connector to provide additional surface area contact for the electrical connection. The alternative embodiment is particularly useful for twin and quad type circuit breakers that would normally have to share a single buss bar connector and for larger amperage circuit breakers (which tend to be more susceptible to overload damage).

In accordance with one aspect, the present invention provides a replacement circuit breaker for electric panelboards that provides the advantages discussed above and overcomes the disadvantages and limitations associated with presently available circuit breakers.

In accordance with another aspect, the present invention provides an improved circuit breaker that facilitates replacement of a circuit breaker in an electric panelboard that has a buss bar connector damaged due to circuit overload or other fault condition when no other circuit breaker positions are available.

In accordance with another aspect, the present invention provides an improved circuit breaker that has a breaker housing with an extension section that extends the electrical connector at the connector end of the housing to connect to a distal bar connector on an unused distal buss bar, identified relative to the parallel mounting rail, and a cavity that substantially straddles the previously utilized, and now damaged, proximal bar connector on a proximally located buss bar.

The present invention provides an improved circuit breaker that has an extension section to extend the breaker housing to a distally located buss bar, a distal electrical connector to engage a bar connector on the distal buss bar, a cavity to substantially straddle the proximally positioned buss bar and a proximal electrical connector to engage a bar connector on the proximal buss bar.

The above and other aspects of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is side view of a circuit breaker configured according to a preferred embodiment of the present invention particularly showing the location of the distal electrical connector relative to the cavity on the bottom side of the breaker housing;

FIG. 2 is a bottom plan view of the circuit breaker of FIG. 1;

FIG. 3 is a top perspective view of a circuit breaker configured according to the present invention shown positioned in a typical electric panelboard;

FIG. 4 is a bottom plan view of an alternative embodiment of the circuit board of the present invention showing a cavity disposed in the middle of the bottom side of the housing; and

FIG. 5 is a bottom plan view of an alternative embodiment of the circuit breaker of the present invention showing an electrical connector disposed in the cavity.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures and drawings are merely illustrative of a preferred embodiment and represent one of several different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein are primarily directed to a single pole circuit breaker, those skilled in the art will readily understand that this is merely for purposes of simplifying the present disclosure and that the present invention is not so limited, as the present invention is equally applicable for multiple pole circuit breakers, such as twin/duplex or quad circuit breakers.

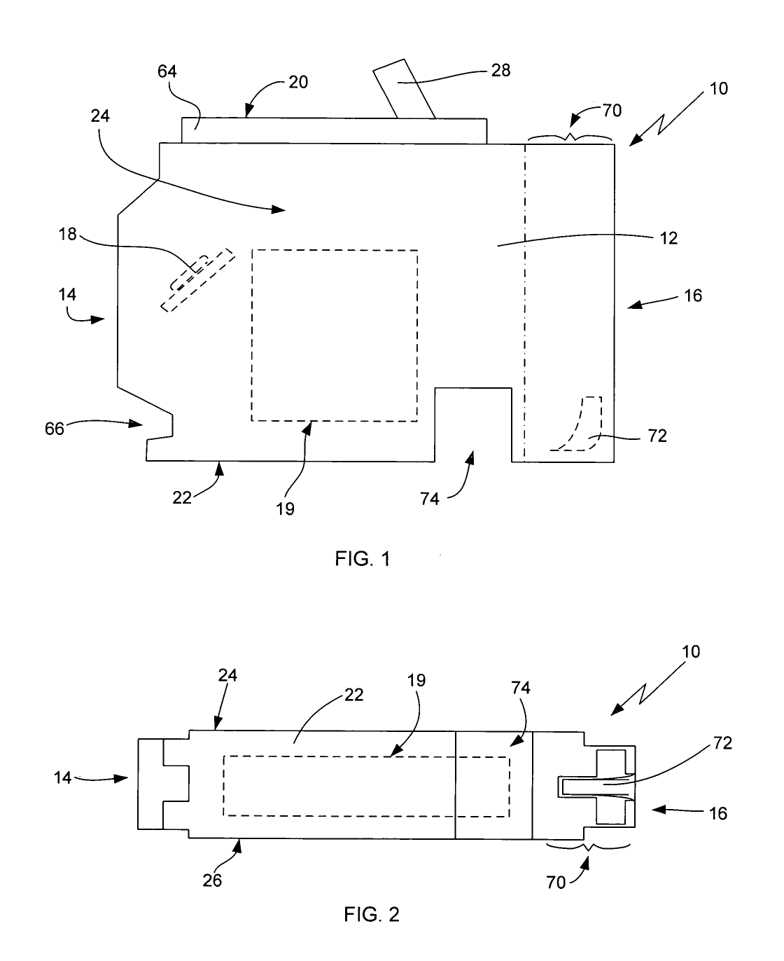

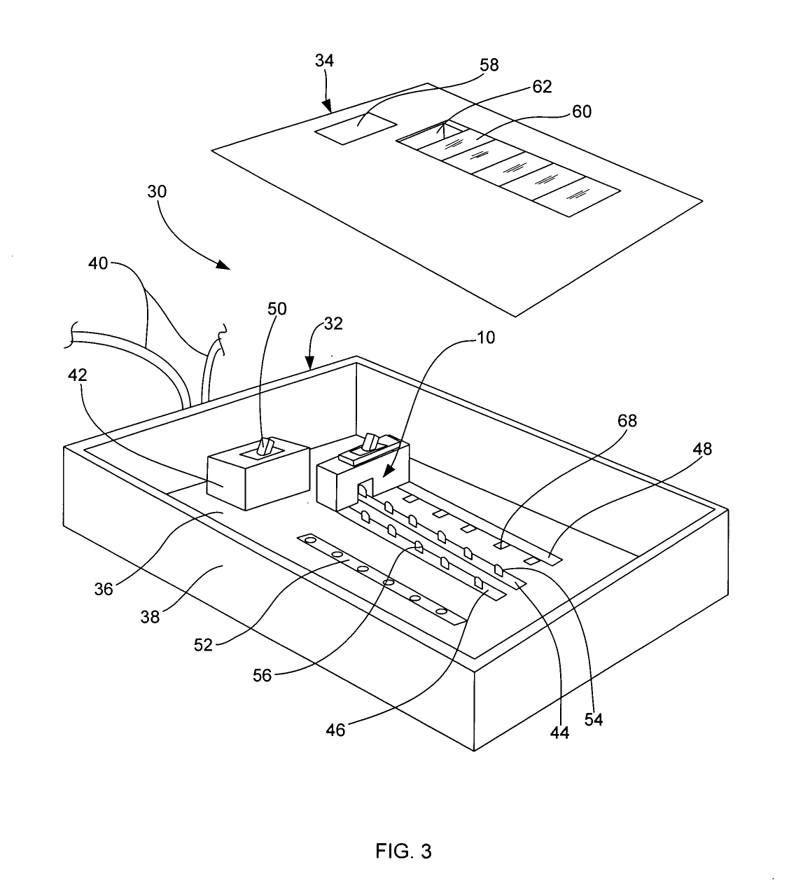

A circuit breaker that is manufactured out of the components and configured pursuant to a preferred embodiment of the present invention is shown generally as 10 in the figures. The primary embodiment of the present invention is best shown in FIGS. 1 and 2, with circuit breaker 10 having a molded breaker housing 12 with a wire terminal end 14 and a connector end 16. Typically, breaker housing 12 is made from plastic or like materials. As with standard prior art circuit breakers, circuit breaker 10 of the present invention is configured with circuit connector mechanism 18 at wire terminal end 14 to connect to a branch circuit, not shown, that distributes electricity throughout a house, commercial building or other structure from a source of electricity, also not shown, such as an electrical generating facility via transmission lines. Typically, but not exclusively, circuit connector mechanism 18 comprises a screw or bolt that threadably engages the operative circuit passing/breaking mechanism, shown generally as 19 in FIGS. 1 and 2, located in the interior of breaker housing 12, as enclosed by top side 20, bottom side 22 and first side wall 24 and opposing second side wall 26. The configuration and operation of various circuit passing/breaking mechanisms 19 suitable for use with circuit breaker 10 of the present invention are well known to those skilled in the art and is not set forth herein. As readily understood by those skilled in the art, in normal operation the circuit passing/breaking mechanism allows electrical current to pass through circuit breaker 10 to a branch circuit unless there is a circuit overload or other fault, which automatically triggers the mechanism to electrically isolate the branch circuit from the source of electricity. As with standard circuit breakers, circuit breaker 10 includes a manual switch 28 on the top side 20 of breaker housing 12 that allows the user to manually engage the breaking mechanism to electrically isolate the branch circuit from the source of electricity.

Circuit breaker 10 of the present invention is configured for use with an electrical panelboard, as exemplified by panelboard 30 shown in FIG. 3, generally comprising a box section 32 and cover plate 34. Box section 32 has a bottom wall 36 and a plurality of upstanding side walls 38 at the periphery thereof. Received into box section 32 are conductor wires 40 that connect to the electrical transmission system to bring electricity to panelboard 30. Once in box section 32, conductor wires 40 typically connect to a master circuit breaker 42 that supplies power to a pair of main power supply buss bars, identified as proximal buss bar 44 and distal buss bar 46, as identified by their positions relative to mounting rail 48. Proximal buss bar 44 and distal buss bar 46 are in spaced apart relation, although located relatively close to each other, and are positioned on bottom wall 36 parallel to each other and to mounting rail 48. Typically, the components are connected to and/or incorporated into a separate molded component that properly positions them relative to each other in box section 32. Master circuit breaker 42 includes a manually operative master switch 50 that allows the user to disconnect all electrical power to proximal 44 and distal 46 buss bars and, therefore, all of the branch circuits connected thereto. Also mounted to the bottom wall 36 of box section 32 is a neutral buss bar 52 which connects the various circuits and components of panelboard 30 to ground. Proximal buss bar 44 has a plurality of proximal bar connectors 54 and distal buss bar 46 has a plurality of distal bar connectors 56 suitable for engagement by circuit breaker 10, as set forth in more detail below. Cover plate 34 attaches to box section 32 to enclose the components therein. The master switch 50 of master circuit breaker 42 extends outwardly through master switch opening 58 in cover plate 34. Cover plate 34 also includes a plurality of knock-out plates 60 that can be removed to provide one or more plate openings 62 (one shown open in FIG. 3) for the reduced width section 64 of circuit breaker 10 to extend therethrough for easy access to manual switch 28.

As with the typical configuration of prior art circuit breakers, wire terminal end 14 of circuit breaker 10 has a rail engagement mechanism, shown as 66 in FIG. 1, configured to removably engage mounting rail 48. In a standard configuration, mounting rail 48 has a plurality of engagement tabs 68, shown in FIG. 3, that extend outwardly from mounting rail 48 toward proximal buss bar 44 that are adapted to be engaged by rail engagement mechanism 66. As shown in FIG. 1, rail engagement mechanism 66 can comprise a shaped and configured area of the wire terminal end 14 of breaker housing 12. As with standard prior art circuit breakers, rail engagement mechanism 66 is configured to allow the user to engage tabs 68 and pivot circuit breaker 10 downward toward the appropriate proximal bar connector 54 on proximal buss bar 44. Standard prior art circuit breakers are configured with an electrical connector that engages one of the proximal bar connectors 54 on proximal buss bar 44 in a manner that provides a electrical connection with the circuit breaker and which secures the circuit breaker inside box section 32 of panelboard 30. The distal bar connectors 56 on distal buss bar 46 are not utilized by prior art circuit breakers. Instead, the distal bar connectors 56 and distal buss bar 46 are covered by cover plate 34.

In the standard prior art configuration, when the user wants or needs to replace a circuit breaker he or she merely pulls back on the circuit breaker to break the connection with proximal bar connector 54, pivots the circuit breaker toward the mounting rail 48 and then removes the circuit breaker from the box section 32. When a proximal bar connector 54 is damaged by overload or other fault condition, the user only has to attach the branch circuit to a new circuit breaker and move the circuit breaker to a new area of the box section 32 and connect the circuit breaker to an unused rail engagement mechanism 66 of mounting rail 48 and to proximal buss bar 44. As described above, however, it is common for all of the circuit breaker locations to be in use, meaning there are no combination mounting rail 48 and proximal buss bar 44 areas open for a new circuit breaker. In this circumstance, the entire panelboard 30 must be replaced. As this requires a person of considerable skill in the area of electrical systems, replacing panelboard 30 can be somewhat costly.

Circuit breaker 10 of the present invention eliminates the need to replace panelboard 30 under the above-identified circumstances. As set forth in more detail below, circuit breaker 10 allows the user to utilize the heretofore unused distal buss bar 46 to electrically connect the incoming electricity with the subject branch circuit. As shown in FIG. 1, circuit breaker 10 has an extended section 70, shown with the bracket and the dash-dot line, in which is positioned distal electrical connector 72 configured to engage and electrically contact one of the distal bar connectors 56. FIG. 3 shows circuit breaker 10 mounted in box section 32 of panelboard 30. Distal electrical connector 72 can be any of the types of electrical connectors commonly available that are utilized in prior art circuit breakers and be positioned at bottom side 22 at or near connector end 16 of circuit breaker 10 (i.e., disposed in a connector cavity at or near connector end 16). As known to those skilled in the art, distal electrical connector 72 must be cooperatively configured with distal bar connector 56 to both physically attach and provide the necessary electrical contact. Distal electrical connector 72 is the same type of electrical connector that connects to proximal bar connector 54 in the prior art circuit breaker. As further known to those skilled in the art, the replacement circuit breaker 10 of the present invention must be provided with the same type of electrical connector that is being replaced due to a damaged proximal bar connector 54 for the type and configuration of panelboard 30 being utilized to properly distribute the electricity from conductor wires 40 to the various branch circuits in the structure.

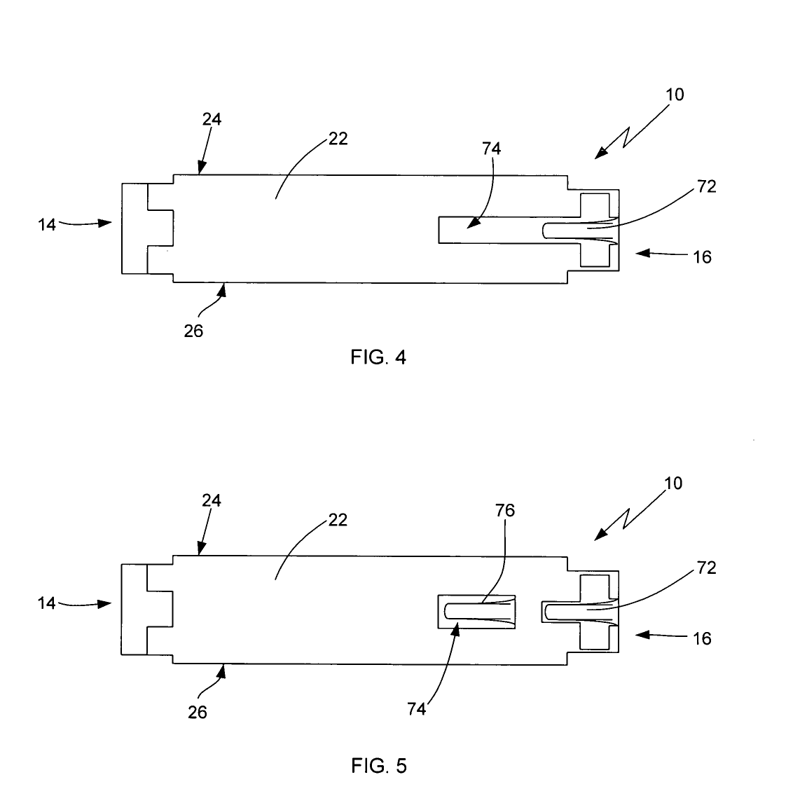

In order to utilize the replacement circuit breaker 10 of the present invention, the user must be able to bypass or skip over the existing damaged proximal bar connector 54. To accomplish this, circuit breaker 10 is provided with a cavity 74 disposed on the bottom side 22 of breaker housing 12. Cavity 74 must be sized and configured to substantially straddle the subject proximal bar connector 54 so that distal electrical connector 72 at the connector end 16 of circuit breaker 10 can be pivoted down onto and connect with the appropriate distal bar connector 56 on distal buss bar 46. The specific size of cavity 74 will be dependent on the maximum size of proximal bar connector 54 which must be accommodated by cavity 74 and yet not be so large as to interfere with circuit mechanism 19 of circuit breaker 10 or substantially (i.e., unsafely) weaken breaker housing 12. In the embodiment shown in FIGS. 1 and 2, cavity 74 extends across bottom side 22 from first side wall 24 to second side wall 26. In the alternative embodiment shown in FIG. 4, cavity 74 is placed in the interior of bottom side 22 and does not extend all the way across. In the configuration of FIG. 4, cavity 74 must be sufficiently wide and long to be fully placed over proximal bar connector 54, preferably without contact therewith. In this manner, when the user engages rail engagement mechanism 66 in mounting rail 48 and pivots circuit breaker 10 downward to lock it into place, as shown in FIG. 3, cavity 74 will be placed over and substantially straddle the upstanding (as typically utilized) proximal bar connector 54 on proximal buss bar 44 to engage the distal electrical connector 72 with distal bar connector 56 on distal buss bar 46.

The configuration of FIGS. 1, 2 and 4, described above, is useful for replacing an existing circuit breaker when the proximal bar connector 54 is damaged due to overload or other fault. The circuit breaker 10 of the present invention can also be configured to provide improved contact when using twin or quad circuit breakers. As set forth above, the current configuration is for both or all of the breakers to share a single proximal bar connector 54 on proximal buss bar 44. As shown in FIG. 5, the circuit breaker 10 can be provided with a proximal electrical connector 76 disposed in cavity 74 to engage an undamaged proximal bar connector 54. In this manner, each component of a twin breaker or only a pair of components for a quad breaker will have its own bar connector, with the proximal electrical connector 76 engaging proximal bar connector 54.and distal electrical connector 72 engaging distal bar connector 56, thereby providing an improved electrical connection and reducing the electrical load on an individual bar connector.

In use, once the user removes the existing circuit breaker from the damaged proximal bar connector 54 in panelboard 30, the replacement circuit breaker 10 of the present invention can be utilized by first engaging rail engagement mechanism 66 with mounting rail 48 and then pivoting circuit breaker 10 downward to engage distal electrical connector 72, located in the extended section 70, with distal bar connector 56 on distal buss bar 46. Cavity 74 will substantially straddle the existing, damaged proximal bar connector 54 on proximal buss bar 44, effectively isolating it from the useful distal bar connector 56. Once engaged, electrical current will flow from distal buss bar 46 through circuit breaker 10 to the branch circuit connected thereto, thereby avoiding the need to replace panelboard 30 when each circuit breaker area is being utilized and one of the proximal bar connectors 54 becomes damaged due to overload or other fault condition. If circuit breaker 10 is configured as a twin or quad circuit breaker, then it will be supplied with a proximal electrical connector 76 in cavity 74 to also engage a non-damaged or functional proximal bar connector 54 on proximal buss bar 44, thereby reducing the load on a single bar connector that exists with the use of existing twin or quad circuit breakers.

While there are shown and described herein specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape and use. For instance, there are numerous components described herein that can be replaced with equivalent functioning components to accomplish the objectives of the present invention.

What is claimed is:

1. A circuit breaker for use in a panelboard having a mounting rail, a proximal buss bar and a distal buss bar, said circuit breaker comprising:
a breaker housing having a wire terminal end configured to removably engage said mounting rail and a connector end having a distal electrical connector configured to engage a distal bar connector on said distal buss bar; and
a cavity disposed in a bottom side of said breaker housing, said cavity positioned so as to substantially straddle a proximal bar connector on said proximal buss bar.

2. The circuit breaker according to claim 1 further comprising a proximal electrical connector disposed in said cavity, said proximal electrical connector configured to engage said proximal bar connector.

3. The circuit breaker according to claim 1, wherein said breaker housing has a first side wall and a second side wall, said cavity extending substantially from said first side wall to said second side wall.

4. The circuit breaker according to claim 1 further comprising a circuit mechanism operatively disposed in said breaker housing.

5. An improved circuit breaker comprising a breaker housing having a wire terminal end and a connector end, said circuit breaker for use in a panelboard having a mounting rail, a proximal buss bar and a distal buss bar, the improvement comprising:
an extended section on said breaker housing at said wire terminal end;
a distal electrical connector in said extended section generally at said wire terminal end, said distal connector configured to engage a distal bar connector on said distal buss bar; and
a cavity disposed in a bottom side of said breaker housing, said cavity positioned so as to substantially straddle a proximal bar connector on said proximal buss bar.

6. The circuit breaker according to claim 5 further comprising a proximal electrical connector disposed in said cavity, said proximal electrical connector configured to engage said proximal bar connector.

7. The circuit breaker according to claim 5, wherein said breaker housing has a first side wall and a second side wall, said cavity extending substantially from said first side wall to said second side wall.

8. The circuit breaker according to claim 5 further comprising a circuit mechanism operatively disposed in said breaker housing.

9. A circuit breaker in a panelboard having a mounting rail, a proximal buss bar and a distal buss bar, said circuit breaker comprising:
a breaker housing having a wire terminal end engaging said mounting rail and a connector end having a distal electrical connector engaging a distal bar connector on said distal buss bar; and
a cavity disposed in a bottom side of said breaker housing, said cavity substantially straddling a proximal bar connector on said proximal buss bar.

10. The circuit breaker according to claim 9 further comprising a proximal electrical connector disposed in said cavity, said proximal electrical connector engaging said proximal bar connector.

11. The circuit breaker according to claim 9, wherein said breaker housing has a first side wall and a second side wall, said cavity extending substantially from said first side wall to said second side wall.

12. The circuit breaker according to claim 9 further comprising a circuit mechanism operatively disposed in said breaker housing.
